(19) United States
(12) Patent Application Publication
(10) Pub. No.: US 2025/0287940 A1
(43) Pub. Date: Sep. 18, 2025

(54) Chitosan-coated mesoporous silica nanoparticles

(71) Applicants: Regents of the University of Minnesota, Minneapolis, MN (US); The Connecticut Agricultural Experiment Station, New Haven, CT (US)

(72) Inventors: Christy L. Haynes, Minneapolis, MN (US); Beza Tuga, Minneapolis, MN (US); Chaoyi Deng, New Haven, CT (US); Jason White, Prospect, CT (US); Tana O'Keefe, Minneapolis, MN (US); Wade Elmer, Wallingford, CT (US)

(21) Appl. No.: 19/065,783

(22) Filed: Feb. 27, 2025

Related U.S. Application Data
(60) Provisional application No. 63/559,437, filed on Feb. 29, 2024.
(60) Provisional application No. 63/559,442, filed on Feb. 29, 2024.

(51) Int. Cl. A01N 25/28; A01C 1/00; A01G 7/06; A01N 59/00; A01P 3/00

(52) U.S. Cl. CPC A01N 25/28; A01C 1/00; A01G 7/06; A01N 59/00; A01P 3/00

(57) ABSTRACT

A method for improving yield in the genus Glycine wherein the method includes applying mesoporous silica nanoparticles to a seed or plant of a member of the genus Glycine. In particular, the method includes applying chitosan to the mesoporous silica nanoparticles producing chitosan-coated mesoporous silica nanoparticles and applying the chitosan-coated mesoporous silica nanoparticles to the seed or plant.

### CROSS REFERENCE TO RELATED APPLICATIONS

This application claims priority to U.S. provisional patent application Ser. No. 63/559,437, filed on Feb. 29, 2024, and U.S. provisional patent application Ser. No. 63/559,442, filed on Feb. 29, 2024, the contents of which are hereby incorporated in their entirety.

### GOVERNMENT LICENSE RIGHTS

This invention was made with government support under CHE2001611 awarded by the National Science Foundation. The government has certain rights in the invention.

### BACKGROUND

This disclosure relates to chitosan-coated mesoporous silica nanoparticles and in particular it relates to chitosan-coated mesoporous silica nanoparticles to promote plant health and growth.

The global population is expected to exceed 9.7 billion by 2050, and current estimates predict that global food production must increase substantially to achieve and maintain global food security. (FAO, The State of Food and Agriculture-Leveraging Food Systems for Inclusive Rural Transformation. 2017). As part of the United Nation's Zero Hunger goal, there are hopes to ensure sustainable food production systems and implement resilient agricultural practices to increase productivity and production by 2030. As an economically important crop, with over 372 million tons being produced globally in 2021, (FAO, Agricultural production statistics (2000-2021). 2022) soybeans can play a crucial role in providing food security and helping to meet the Zero Hunger goal.

However, plant diseases pose a huge threat to agriculture, with anywhere from 20-40% of crops being lost to pathogens each year. (Savary, S. et al. “Crop losses due to diseases and their implications for global food production losses and food security.” Food Security 2012, 4 (4), 519-537.) Fusarium diseases are significant hindrances to food plant production as there are at least 20 different species that infest more than two dozen crop species. (Wang, H et al., 2011) Specifically, Fusarium virguliforme (FV) is a soil-borne fungal pathogen that causes sudden death syndrome (SDS) to soybeans (Glycine max). When infected with FV, phytotoxins move from roots to shoots within the plant's vascular system, causing SDS and resulting in tissue damage and discoloration to foliar tissues. (Brar, H. et al., 2011; Pudake, R. N. et al., 2013). SDS is widespread in the United States and has resulted in $6.75 billion dollars in losses from 1996 to 2016, with annual yield losses ranging from 0.6 to 1.9 million metric tons from 2006 to 2014. (Allen, T. et al. 2017; Bandara, A. et al., 2020).

The protection of crops from plant diseases plays an obvious and important role in meeting the growing global demand for food; ideally, this would be done without increased application of pesticides or soil fumigation. Management of SDS has been challenging, although techniques such as fungicide seed treatments, (Kandel, Y., et al. 20231 Hartman, G. L., et al., 2015) breeding and selection of cultivars with host-plant resistance, (Chawla, S. B., et al., 2013; Lin, F. et al., 2022) improving soil drainage, (Vick, C. et al. 2003) and crop rotation (Leandro, L. L. et al., 2012) have had limited success. However, none of these management options have performed well across a range of environmental conditions that plants may experience in the field. Thus, there is a pressing need for sustainable agricultural techniques to manage these pathogens.

Previously, nanoparticles (NPs) have proved to be an effective treatment for Fusarium strains in other plants species such as watermelon (Citrullus lanatus) (Buchman, J. T., et al. 2019; Borgatta, J. et al. 2018; Kang, H. et al. 2021), tomatoes (Solanum lycopersicum) (Ma, C. et al. 2019; Adisa, I. O. et al., 2018) and lettuce (Lactuca sativa) (Ahmed, A. et al. 2016) due to the small size that allows for enhanced plant uptake and distribution. Silica NPs are a sustainable option for use in agriculture as silicon is the second most abundant element in the Earth's crust. Furthermore, silicon, while not an essential nutrient for plants, can enhance plant health and growth and has been found to alleviate many abiotic and biotic stresses within plants. (Currie, H. A., et al., 2007; Mathur, P. et al. 2020). Silicon is usually acquired through a plant's roots as silicic acid, where it can then form a cuticle-silica double layer barrier that fortifies the plant's cell wall to facilitate protection against disease. (Currie, H. et al. 2007). Additionally, silicon activates plant defense mechanisms through the production of stress hormones, such as phytoalexins, or through the synthesis of antimicrobial compounds within the plant. (Fauteux, F. et al. 2005). Silica NPs are known to dissolve to release silicic acid, and Kang et al. has shown that the dissolution rate correlates with the suppression of Fusarium wilt, with faster dissolution increasing crop health and fruit yield in watermelon (C. lanatus). Furthermore, mesoporous silica nanoparticles (MSNs) have high surface areas and pore volumes that make them particularly useful for agrochemical delivery; this has been demonstrated in tomatoes (S. lycopersicum) (Li, W. et al., 2023), cucumber (Cucumis sativa) (Zhao, P. 2018), wheat (Triticum aestivum), and soybeans (G. max) (Wang, J. et al. 2023).

Chitosan, an organic polysaccharide, has also been shown to increase disease resistance by initiating a signaling cascade within plants to increase their natural defense mechanisms. (El Hadrami, A. et al. 2010; Chandra, S. et al. 2015). In addition to the enhancement of natural defense mechanisms, chitosan has been reported to have antifungal properties that may provide protection against pathogens. (Saharan, V. et al. 2013; Zing, K. et al. 2014). Furthermore, chitosan is naturally derived from chitin, also making it a sustainable material for use in agriculture. For these reasons, chitosan NPs have been applied in agricultural applications with demonstrated disease suppression in tomatoes (S. lycopersicum) (Narasimhamurthy, K et al. 2022) and chickpeas (Cicer arietrium) (Sathiyabama, M. et al. 202). Since silica NPs and chitosan act through two different mechanisms to alleviate plant disease, these two materials have been combined together to further enhance disease suppression. (Nguyen, N. T. et al., 2023; Lin, Y. et al 2011). Although previous work with CTS-MSNs showed suppression of Fusarium wilt and enhanced plant growth in species known to accumulate Si, such as watermelon, much remains unknown about other plant species, including soybeans, that are low Si accumulators.

### SUMMARY

This disclosure relates to a method for improving yield in the genus Glycine, the method comprising by applying mesoporous silica nanoparticles to a seed or plant of a member of the genus Glycine

In another embodiment of this disclosure the method comprises applying chitosan to the mesoporous silica nanoparticles producing chitosan-coated mesoporous silica nanoparticles and applying the chitosan-coated mesoporous silica nanoparticles to the seed or plant

In another embodiment of this disclosure the member of the genus Glycine comprises Glycine max

In another embodiment the method comprises the mesoporous silica nanoparticles being applied to the plant of the member of the genus Glycine by foliar exposure to a mesoporous silica nanoparticle suspension to coat leaves of the plant with the mesoporous silica nanoparticle suspension.

In another embodiment the mesoporous silica nanoparticles were applied to the seed of the member of the genus Glycine by infusing the seed with the mesoporous silica nanoparticle suspension.

In another embodiment the seed is infused via a vacuum.

In another embodiment the mesoporous silica nanoparticles comprise fluorescent mesoporous silica nanoparticles and the seeds are infused with the fluorescent mesoporous silica nanoparticles and subjected to fluorescent imaging to determine the extent of infiltration.

The method can then further include adjusting one or more of a vacuum pressure, vacuum treatment time of the seeds in the suspension, a concentration of the fluorescent nanoparticles in the suspension, the composition of the suspension, the pH of the suspension, pretreatment of the seeds, or combination thereof based on the extent of infiltration based on confocal imaging or fluorescent imaging results for optimization.

In another embodiment chlorophyll levels for a disease infected member of the genus Glycine treated with the chitosan-coated mesoporous silica nanoparticles.

In another embodiment the application of the chitosan chitosan-coated mesoporous silica nanoparticle resulted in a biofortification increase of approximately 23 to 86 percent of micronutrients comprising Zn, Mn, Mg, K, and/or B.

In another embodiment the mesoporous silica nanoparticles were applied to the seed or plant in an amount sufficient to reduce disease progression by approximately 12%

In another embodiment the chitosan coated mesoporous silica nanoparticles were applied to the seed or plant in an amount sufficient to reduce disease progression by approximately 15%

In a further embodiment, this disclosure relates to a method of infusing seeds from a member of the genus Glycine, with mesoporous silica nanoparticles. The method includes providing a suspension of the mesoporous silica nanoparticles; placing the seeds in the mesoporous silica nanoparticle suspension; positioning the seeds in the mesoporous silica nanoparticle suspension in a vacuum chamber where a vacuum is pulled; and releasing the vacuum thereby infusing the seeds with the mesoporous silica nanoparticle suspension.

This embodiment further includes the method wherein the mesoporous silica nanoparticle suspension comprises chitosan in combination with the mesoporous silica nanoparticles.

In another embodiment, this disclosure describes combating Fusarium virguliforme. in a member of the genus Glycine. The method comprises applying mesoporous silica nanoparticles to a seed of the genus Glycine.

This embodiment further comprises applying to the seed chitosan with the mesoporous silica nanoparticles.

This embodiment further comprises a plant resulting from the seed in a biofortification increase of approximately 23 to 86 percent of micronutrients comprising Zn, Mn, Mg, K, and/or B.

This embodiment further comprises the mesoporous silica nanoparticles being applied to the seed in an amount sufficient to reduce disease progression by approximately 12%.

This embodiment further comprises the mesoporous silica nanoparticles with chitosan being applied to the seed or plant in an amount sufficient to reduce disease progression by approximately 15%.

### BRIEF DESCRIPTION OF DRAWINGS

FIG. 1 is a representative thermogravimetric analysis of MSNs (dark) and CTS-MSNs (light).

FIGS. 2A and 2B are representative TEM images of a) MSNs and b) CTS-MSNs.

FIG. 2C-2F are physical characteristics of bare MSNs and CTS-MSNs after performing the chitosan coating with a (FIG. 2C) hydrodynamic diameter increase upon coating and (FIG. 2D) a less negative potential observed for CTS-MSNs. A (FIG. 2E) decrease in the surface area that indicates blocked pores in the CTS-MSNs, and (FIG. 2F) a decrease in pore volume, again indicating blockage of the pores by chitosan. Error bars represent the standard deviation of triplicate measurements. Paired t-tests were used to determine statistical significance. **p<0.01, ***p<0.001.

FIG. 3 shows silicomolybdic acid spectrophotometric assay results for three material replicates of MSNs (dark) and CTS-MSNs (light) in simulated xylem sap.

FIG. 4 is an experimental scheme for the greenhouse and field studies.

FIG. 5 shows AUDPC for Fusarium-infected plants that received foliar application (left side) and seed application (right side) of different forms of Si and/or chitosan. The error bars represent the standard error of five replicate plants. A one-way ANOVA with Dunnett's multiple comparisons was used to evaluate the statistical significance for foliar and seed applications separately. Graphs for foliar and seed application are shown together for ease of comparison. **p<0.01.

FIG. 6 shows silicon content in soybean seeds after a 250 mg/L seed treatment with MSNs and CTS-MSNs. A one-way ANOVA with Tukey's multiple comparisons was used to evaluate statistical significance. *p<0.05, **p<0.01.

FIG. 7A-7B show chlorophyll content for foliar and seed treatments in (FIG. 7A) healthy plants and (FIG. 7B) Fusarium-infected plants for the greenhouse study. A one-way ANOVA with Dunnett's multiple comparisons was used to evaluate statistical significance. *p<0.05, **p<0.01.

FIG. 8A-8F are ICP-OES results for the greenhouse study with Si content in the shoots of (FIG. 8A) healthy plants and (FIG. 8B) Fusarium-infected plants; the roots of (FIG. 8C) healthy plants and (FIG. 8D) Fusarium-infected plants; and the soybean pods of (FIG. 8E) healthy plants and (FIG. 8F) Fusarium-infected plants. The error bars represent the standard error of five replicate plants. A one-way ANOVA with Dunnett's multiple comparisons was used to evaluate statistical significance for foliar and seed applications separately. Graphs for foliar and seed application are shown together for case of comparison. *p<0.05, **p<0.01.

FIG. 9A-9B show ICP-OES determination of total silicon concentration (includes aboveground tissues, roots, and soybean pods) for five replicate plants. The error bars represent the standard error of five replicate plants. A one-way ANOVA with Dunnett's multiple comparisons was used to evaluate statistical significance for foliar and seed applications separately. Graphs for foliar and seed application are shown together for easy comparison. *p<0.05, ****p<0.0001.

FIG. 10A-10F show fresh weight of the shoots of (FIG. 10A) healthy plants and (FIG. 10B) Fusarium-infected plants; the roots of (FIG. 10C) healthy plants and (FIG. 10D) Fusarium-infected plants; the soybean pods of (FIG. 10E) healthy plants and (FIG. 10F) Fusarium-infected plants. The error bars represent the standard error of five replicate plants. A one-way ANOVA with Dunnett's multiple comparisons was used to evaluate statistical significance for foliar and seed applications separately. Graphs for foliar and seed application are shown together for case of comparison. *p<0.05, **p<0.01.

FIG. 11A-11C show (FIG. 11A) AUDPC for Fusarium-infected plants. Chlorophyll content for (FIG. 11B) healthy plants and (FIG. 11C) Fusarium-infected plants. The error bars represent the standard error of five replicate plants. A one-way ANOVA with Dunnett's multiple comparisons was used to evaluate statistical significance. ***p<0.001.

FIG. 12A-12D show field data for fresh weight for the shoots of (FIG. 12A) healthy plants and (FIG. 12B) Fusarium-infected plants as well as the soybean pods of (FIG. 12C) healthy plants and (FIG. 12D) Fusarium-infected plants. The error bars represent the standard error of five replicate plants. A one-way ANOVA with Dunnett's multiple comparisons was used to evaluate the statistical significance. *p<0.05.

FIG. 13A-FIG. 13F show ICP-OES for shoots of (FIG. 13A) healthy plants and (FIG. 13B) Fusarium-infected plants; roots of (FIG. 13C) healthy plants and (FIG. 13D) Fusarium-infected plants; soybean pods for (FIG. 13E) healthy plants and (FIG. 13F) Fusarium-infected plants. The error bars represent the standard error of five replicate plants. A one-way ANOVA with Dunnett's multiple comparisons was used to evaluate statistical significance. *p<0.05, **p<0.01, ****p<0.0001.

FIG. 14A-14E show concentration of (FIG. 14A) Cu, (FIG. 14B) K, (FIG. 14C) Fc, (FIG. 14D) S, and (FIG. 14E) A1 in the soybean pods of diseased plants as determined by ICP-OES. The error bars represent the standard error of five replicate plants. A one-way ANOVA with Dunnett's multiple comparisons was used to evaluate statistical significance. *p<0.05, **p<0.01.

FIG. 15A-15E show concentration of (FIG. 15A) B, (FIG. 15B) K, (FIG. 15C) Mn, (FIG. 15D) Mg, and (FIG. 15E) Zn in the soybean pods of healthy plants as determined by ICP-OES. The error bars represent the standard error of five replicate plants. A one-way ANOVA with Dunnett's multiple comparisons was used to evaluate statistical significance. *p<0.05, **p<0.01, ****p<0.0001.

FIGS. 16a and 16b5a and 5b are schematic representations of the vacuum infiltration and confocal imaging process respectively. FIG. 16a illustrates vacuum infiltration of soybean seeds that removes air from the seed coat and allows for incorporation of RITC-UMNs into the soybean seed and FIG. 16b illustrates sample and slide preparation for confocal imaging.

FIGS. 17a and 17b. Vacuum infiltration and seed priming comparison. The mean fluorescence intensity for vacuum infiltration and seed priming for (FIG. 17a) the seed exterior and (FIG. 17b) the seed interior. Error bars represent the standard error of three seed replicates. A one-way ANOVA with Tukey's multiple comparisons was used to evaluate statistical significance although none was observed.

FIGS. 18a and 18b are graphical representations of testing infiltration time and concentration. FIG. 18a illustrates vacuum infiltration results for 0, 125, 250, and 500 mg/L RITC-UMNs with infiltration times of 10, 20, or 30 minutes. FIG. 18b illustrates vacuum infiltration results for 0, 125, 250, and 500 mg/L APTES-modified RITC-UMNs with infiltration times of 10, 20, or 30 minutes. Error bars represent the standard error of three seed replicates. A two-way ANOVA with Tukey's multiple comparisons test was used to evaluate the statistical significance for RITC-UMNs and APTES-modified RITC-UMNs. *p<0.05.

FIG. 19 is a graphical representation fluorescence for the seed interior of RITC-UMN and APTES-modified RITC-UMN treatments. 500 mg/L and 30-minute seed samples were used to understand the correlation between the fluorescence observed on the exterior and interior of soybean seeds upon vacuum infiltration. Error bars represent the standard error of three seed replicates. Unpaired t-test for RITC-UMNs and APTES modified RITC-UMNs were used to evaluate statistical significance. The error bars represent the standard error of triplicate seeds. **p<0.01.

### DETAILED DESCRIPTION

There is a need to develop new and sustainable agricultural technologies to help provide global food security. In this disclosure, mesoporous silica nanoparticles (MSNs) and chitosan-coated mesoporous silica nanoparticles (CTS-MSNs) were synthesized and applied to soybeans (Glycine max) by two different strategies in greenhouse and field studies to study the role of dissolved silicic acid and chitosan in enhancing plant growth and suppressing disease damage caused by Fusarium virguliforme.

Plant growth and health were assessed by measuring soybean biomass and chlorophyll content in both healthy and Fusarium-infected plants at harvest. In the greenhouse study, foliar and seed applications with 250 mg/L nanoparticle treatments were compared with each other A single seed treatment of MSNs reduced disease severity as judged by physical characteristics and appearance of the plants (rated on a scale of 1-5, AUDPC defined below) by approximately 30% and increased chlorophyll content in both healthy and infected plants by approximately 12%. Based on greenhouse results, seed application was used in the follow-up field study, and MSNs and CTS-MSNs reduced disease progression by approximately 12% and 15%, respectively. A significant increase of approximately 32% was observed for chlorophyll content for plants treated with CTS-MSNs. Perhaps most important, nanoscale silica seed (without chitosan) treatment significantly increased (approximately 23-68%) the micronutrient (Zn, Mn, Mg, K, B) content of soybean pods, suggesting a potential sustainable strategy for nano-enabled biofortification to address nutrition insecurity. Overall, these findings indicate that MSN and CTS-MSN seed treatments in soybeans can enable disease suppression and increased plant health as part of a nano-enabled strategy for sustainable agriculture.

For purposes of this disclosure, a plant micronutrient is a chemical element that is essential for the growth and development of plants. Such micronutrients are taken up by plants from the soil or growing medium and are used in various physiological and biochemical processes critical to the plant's life cycle, including photosynthesis, energy transfer, cell division, and the synthesis of proteins, enzymes, and other important compounds. A non-exhaustive list of micronutrients includes iron (Fe), boron (B), chlorine (Cl), manganese (Mn), zinc (Zn), copper (Cu), molybdenum (Mo), and nickel (Ni).

Biofortification for purposes of this disclosure refers to the process of increasing the density of vitamins and minerals in a plant, with the aim of improving the nutritional quality of the plant. Biofortification addresses nutrient deficiencies by enhancing the nutritional content of the plant. Biofortification differs from conventional fortification, where a nutrient would be added during processing of the plant or its fruit for consumption.

Chitosan is not a nutrient for plants. Chitosan is a biopolymer derived from chitin, found in the exoskeleton of crustaceans and insects, and is known for its biodegradability, biocompatibility, and antimicrobial properties. In agricultural and horticultural contexts, chitosan is used as a biostimulant, elicitor, and soil amendment to enhance plant growth, improve stress tolerance, and stimulate immune responses. Chitosan aids the plant in up taking micronutrients especially through the plant's roots. Chitosan is disclosed herein for that purpose. Soybeans are low silicon accumulators and chitosan as shown herein aids soybeans in accumulating silicon.

According to this disclosure, mesoporous silica nanoparticles (MSNs) and chitosan-coated mesoporous silica nanoparticles (CTS-MSNs) were applied to soybeans (Glycine max) to assess their impact on indicators of plant health. MSNs were synthesized and coated with chitosan under acidic conditions to produce CTS-MSNs. Both MSNs and CTS-MSNs were characterized with dynamic light scattering (DLS), C-potential measurements, transmission electron microscopy (TEM) and nitrogen physisorption, in addition to a silicomolybdic acid (SMA) spectrophotometric assay to assess their dissolution behavior prior to plant application. A vacuum infiltration technique was used to infiltrate MSNs and CTS-MSNs into soybean seeds, and this exposure route was compared to the traditional foliar application in a greenhouse study. Plant growth, biomass, and chlorophyll content were assessed in healthy and Fusarium-infected plants. The silicon content in plant shoots, roots, and soybean pods was determined with inductively coupled plasma-optical emission spectroscopy (ICP-OES).

The greenhouse findings revealed the effectiveness of an MSN seed treatment in enhancing plant growth and reducing disease progression; thus, a seed treatment was advanced to a field study where CTS-MSNs showed higher disease suppression, suggesting that CTS-MSNs may have more of a long-term impact on soybeans. In the field, nanosilica treatment also significantly increased the micronutrient content of soybean pods. Together, these studies show the impact of combining mesoporous silica nanoparticles with chitosan on an economically important crop, soybeans, which offers great potential as a sustainable solution for nano-enabled agriculture.

The content of silicon uptake in the seed and/or plant can be measured using various techniques. Elemental analysis of macronutrients and micronutrients can be performed using inductively coupled plasma optical emission spectroscopy (ICP-OES; iCAP 6500, Thermo Fisher Scientific, Massachusetts).

It is also disclosed that the infiltration of the silicon particles into the seed can be measured and the results utilized for purposes of adjusting the parameters of methods disclosed herein including but not limited to vacuum conditions. In such embodiments, nanoparticles comprising fluorescent silica nanoparticles that are formed by way of a fluorescent dye, such as Rhodamine B isothiocyanate (RITC), are integrated into a silica framework of ultraporous mesostructured silica nanoparticles (UMNs) and these UMNs are used for optimizing the methods according to one or more embodiments described herein. These nanoparticles are used for the systematic investigation and optimization of the novel vacuum infiltration method described herein and which incorporates nanoparticle treatments into seeds. Examples disclosed herein use soybean (Glycine max) seeds. However, the optimization and/or use of vacuum treatment for infiltrating nanoparticles into seeds can be used with any seed, including by not limited to edible seeds, legumes or the like.

Vacuum-infiltrated seeds treated with the above conditions were imaged using a confocal microscope to allow for the detection of fluorescent RITC-UMNs and APTES-functionalized RITC-UMNs that were incorporated into the seeds. Since autofluorescence of plant tissue is a concern for fluorescence-based characterizations of soybeans, spectral images were acquired and coupled with a post-acquisition linear unmixing algorithm to resolve the fluorescence contribution solely from the RITC-UMNs. The average fluorescence intensity of the RITC-UMN channel was used to compare the NP infiltration across all conditions considering fluorescence both in the seed coat and in the embryo.

### Experimental Section

Materials. Cetyltrimethylammonium bromide (CTAB), tetraethyl orthosilicate (TEOS), chlorotrimethylsilane (TMS), chitosan (50-190 kDa), ammonium molybdate tetrahydrate, oxalic acid, 4-methylaminophenol sulfate, sodium sulfite (anhydrous), concentrated hydrochloric acid (37%), and silicon standard solution (1000 ppm) were obtained from Sigma-Aldrich (St. Louis, MO). Ammonia nitrate (NH₄NO₃), citric acid, malic acid, and concentrated sulfuric acid (95-98%) were obtained from Fisher Chemical (Ottawa, ON). Malic acid was obtained from Acros Organics (Geel, Belgium). 2-[methoxy (polyethyleneoxy) 9-12propyl]-trimethoxysilane, tech-90 was obtained from Gelest, Inc. (Morrisville, PA). Ammonium hydroxide (NH₄OH, 28-30% as NH₃), glacial acetic acid, and sodium hydroxide were purchased from Avantor (Radnor, PA). Absolute ethanol was acquired from Decon Labs, Inc. (King of Prussia, PA). Ultrapure water was purified from a Milli-Q Millipore water purification system (Billerica, MA).

Synthesis of MSNs. MSNs were synthesized using a previously reported method with modifications.³⁶ Briefly, 0.29 g of CTAB was mixed with 150 g of 0.256 M NH₄OH in an Erlenmeyer flask and was covered and stirred for 1 h at 500 rpm and 50° C. After 1 h, 2.5 mL of 0.88 M TEOS in ethanol was added dropwise via addition funnel. This solution was stirred for 1 h at 700 rpm and 50° C. to form the silica framework around the CTAB micelles. Next, 450 μL 2-[methoxy-(polyethyleneoxy)₉₋₁₂propyl]-trimethoxysilane was slowly added to the solution and stirred for 30 min at 700 rpm and 50° C. Then, 68 μL of TMS was added and stirred for 30 min at 700 rpm and 50° C. After the 30 min, the solution was aged in a beaker at 50° C. for 20 h. The MSNs were purified using ultracentrifugation at 61,579×g, under vacuum, for 30 min. The supernatant was removed, and the pellet was re-dispersed in 6 g/L ethanolic NH₄NO₃ to perform an ion exchange reaction to remove the CTAB micelles. The suspension was stirred under reflux for 1 h at 50° C. before ultracentrifuging and washing with 190 proof ethanol. Another reflux step using 6 g/L ethanolic NH₄NO₃ was carried out with three more washes with increasing ethanol concentrations (95%, 99%, and 99% ethanol in water). The final suspension was dried using rotary evaporation to collect the dried MSNs.

Chitosan Coating of MSNs. A procedure from Chen et al. was adapted for coating the MSNs with chitosan. (Chen, F. et al. 2012). Briefly, a 0.6% w/v solution of chitosan was prepared in 10% v/v acetic acid in water. The pH of the solution was adjusted to 5.5 with 1 M NaOH and then dried MSNs were added to the chitosan solution to prepare a 0.5% w/v suspension (typically with 100 mg of MSNs added to 20 mL of chitosan solution). The suspension was then stirred at room temperature for 48 h to allow for the formation of hydrogen bonds between the silanol groups on the surface of the MSNs and the amine groups on chitosan. Excess chitosan was removed by centrifugation at 17,000×g for 15 min. Chitosan-coated MSNs (CTS-MSNs) were then resuspended in Milli-Q water and dried using a rotary evaporator.

Transmission Electron Microscopy (TEM). To prepare the MSNs for TEM, the nanoparticles were suspended in ethanol at 0.5-1 mg/mL and sonicated for 15 min to ensure adequate dispersion. Then, 200 mesh copper grids with Formvar and carbon supports (Ted Pella, Inc., Redding, CA) were dipped into the suspension and dried in an oven at 50° C. for 5 min. For CTS-MSNs, the nanoparticles were suspended in Milli-Q water at 0.5 mg/mL. TEM grids were dipped in solution and dried as described above. TEM images were acquired by random sampling of grid sections using a FEI Tecnai Spirit Bio-Twin transmission electron microscope using a 120 kV operating voltage.

Dynamic Light Scattering and ζ-Potential Measurements. After the synthesis of MSNs and coating CTS-MSNs, the nanoparticles were resuspended in water at 0.5-1 mg/mL. The suspensions were sonicated for 15 minutes prior to characterization to ensure adequate dispersion. The hydrodynamic diameters and ζ-potentials were then determined for three material replicates using a Malvern Zetasizer Pro instrument (Westborough, MA).

Nitrogen Physisorption. Nitrogen physisorption was performed to determine the surface area and pore volume of the MSNs and CTS-MSNs. Approximately 60 mg of MSNs or CTS-MSNs were added to the sample glassware. The samples were degassed prior to analysis at cryogenic temperatures on a Micromcritics ASAP 2020 instrument (Norcross, GA). The surface area and pore volume were determined using the Brunauer-Emmett-Teller (BET) and Barrett-Joyner-Halenda (BJH) methods, respectively.

Silicomolybdic Acid (SMA) Spectrophotometric Assay. Two solutions were prepared for the silicomolybdic acid assay that has been previously reported. (Coradin, T. et al. 2004) Solution A was prepared by mixing 30 mL of concentrated hydrochloric acid into 400 mL of Milli-Q water in a 500 mL volumetric flask. Next, 10 g of ammonium molybdate tetrahydrate was added and the solution was diluted to 500 mL with Milli-Q water. Solution B was prepared by mixing 100 mL of concentrated sulfuric acid into 800 mL of Milli-Q water in a IL volumetric flask. Then, 20 g of oxalic acid, 6.67 g of 4-methylaminophenol sulfate, and 4 g of anhydrous sodium sulfite were added. The solution was diluted to 1 L with Milli-Q water. The assay was performed in simulated xylem sap which consisted of 1.71 mM citric acid and 890 M malic acid in Milli-Q water with an adjusted pH of 6.0.16 For the assay, each nanoparticle was dispersed in simulated xylem sap at 250 mg/L and sonicated to ensure adequate dispersion. The suspensions were incubated at ambient temperature for the duration of the experiment (50 days). At each timepoint, 0.5 μL of the suspension was removed and diluted with 800 μL of Milli-Q water in a 48-well plate. Then, 75 μL of solution A was added and incubated for 10 minutes at ambient temperature. Next, 375 μL of solution B was added. The plate was incubated at ambient temperature for 2 h. Optical density measurements at 810 nm were taken on a Biotek Synergy HI microplate reader (Winooski, VT) to quantify reduced silicomolybdic acid also known as the molybdenum blue complex. The silicic acid concentration was calculated by comparison of the optical densities of the sample mixtures to those of the diluted silicon standard solutions.

Seed Germination and Transplanting. For the greenhouse experiment, plastic pots measuring 12.5 cm in diameter and 10 cm in height underwent cleaning with Milli-Q water before being filled with 0.5 L of commercial potting mix soil (Pro-Mix BX, Premier Hort Tech, Quakertown, PA) purchased from a local market in New Haven, CT. The potting soil contained a Si content of 30.2±0.5 mg/kg. The germination of soybean seeds occurred in a starter germination kit, and after a 15-day period, the seedlings were transplanted individually into each pot. Post-sowing, the seedlings and ensuing plants were cultivated in a greenhouse maintaining a temperature range of 25±5° C. Regular watering was administered to sustain soil moisture at approximately 60% of its field capacity, occurring every two days, without any additional fertilizer application. The arrangement of the pots followed a completely randomized design.

For the field experiment, the experimental site was established at the Connecticut Agricultural Experiment Station's Lockwood Farm located in Hamden, Connecticut. The soil was previously characterized as a Cheshire Fine Sandy Loam with a pH of 5.9. Microplots were established in spring 2023 with rows 0.9 m wide and spaced 6 m apart. The plots were fertilized with 112 kg/ha of Oct. 10, 2010 NPK, covered with black plastic mulch, and irrigated using drip tape. Thirty microplots were created within the rows, each separated by 30 cm. Seedlings grew for four weeks in plastic liners (36-cell, 5.66×5.66×4.93 cm³) with potting soil substrate before transplanting. No fertilizer was applied during this period. Uniform, four-week-old seedlings were selected as transplants for the field study. In Fusarium-infested microplots, planting holes were hand-mixed with 0.75 g of millet inoculum (see below) just before transplanting. For non-infested plots in adjacent rows, the same preparation method was used, but no pathogen was introduced.

Preparation of Millet Inoculum. The pathogen inoculum was prepared according to previous reports set forth in Deng et al. (., Nanoscale CuO charge and morphology control Fusarium suppression and nutrient biofortification in field-grown tomato and watermelon. Sci Total Environ 2023, 905, 167799). Briefly, millet (Echinochloa esculenta) seeds were autoclaved in distilled water (1:1, wt:wt) for 1 h seeded with two agar plugs colonized with Fusarium virguliforme (FV). After incubating at 22-25° C. for three weeks, the millet was air-dried, ground, sieved to 1 mm, and added to the soil.

Nanoparticle Application. In this study, we employed two methods of Si-based nanoparticle amendment to soybean plants: seed infiltration and foliar spray. By comparing these methods, we aimed to discern the most effective approach for introducing Si-based materials into the plants. For seed infiltration, the seeds were treated separately with CTS-MSN, MSN, chitosan control, or silicic acid control suspension/solution to achieve final Si concentrations of 250 mg/kg, aligning with levels used in field soils in prior research.¹⁵ Following immersion in the suspension/solution, the seeds underwent a 30-minute vacuum infiltration to remove air, followed by a 30-minute rest to facilitate penetration of the suspension/solution. The control treatment involved the addition of only Milli-Q water. Regarding the foliar spray method, suspensions/solutions were loaded into different commercial spray bottles and sonicated before application. The plants received 5 mL of suspension every two days for a total of three applications (15 mL overall), with the initial spray administered five days post-transplanting. This yielded a total of 3.75 mg (250 mg/L) of silica per plant, mirroring the seed treatment. To prevent contamination, the soil surface was covered with plastic film prior to application. Ten replicates were established for each treatment for both application methods.

Plant Harvest. Plants were rated weekly for disease progression based on plant shoot system phenotype, and the area-under-the-disease-progress curve (AUDPC) was calculated using Eq. 1 shown below. Disease severity was determined based on a scale of 1-5, where 1=healthy, 2=slightly stunted, 3=partially stunted, 4=severely stunted, 5=completely stunted or dead. AUDPC calculations were made using the trapezoid rule:

$$AUDPC = [ {D}_{i} + {D}_{( i + 1 )} ] / 2 \times ( {t}_{( i + 1 )} - {t}_{i} ) \qquad ( Eq . 1 )$$

where Dᵢ=the disease rating at time ti. Sixty days post-transplanting, plants were harvested. Root, shoot, and pod samples were collected and underwent three thorough cleanings with Milli-Q water to eliminate soil and nanoparticles adhered to their surfaces before subsequent analysis. Prior to harvesting, the average chlorophyll content of five randomly chosen leaves from each plant was measured using a handheld single-photon avalanche diode chlorophyll meter (SPAD, Minolta Camera, Japan). Following harvest, fresh samples were weighed and oven-dried at 70° C. for three days for subsequent analysis.

Nutrient Analysis. For the assessment of elemental content in tissues, dry samples were ground in a mortar, and 0.2 g was precisely weighed into 50 mL digestion tubes. Subsequently, 5 mL of trace pure nitric acid was added to each sample. The samples underwent digestion in a digiPrep hot block (SCP Science, Quebec, Canada) for 45 minutes at 115° C. Following digestion, the tubes were brought to a 50 mL volume with MW. The Si concentration, along with selected macro and micro elements, was determined using an inductively coupled plasma-optical emission spectrometer (ICP-OES, Perkin-Elmer Optima 4300 DV; Shelton, CT). To ensure quality control, a blank sample and a NP-spiked sample of known content were analyzed every 30 samples. Additionally, a standard reference material (NIST 2709a, Gaithersburg, MD) was included.

Statistical Analysis. For comparisons for the characterization of MSNs and CTS-MSNs, paired t-tests were used to determine statistical significance. Values reported for the MSN and CTS-MSN characterization are denoted as mean ± standard deviation. For plant exposures, statistical analysis was performed separately for foliar and seed application and on healthy and Fusarium-infected plants using a one-way ANOVA with Dunnett's multiple comparisons test (p<0.05) unless otherwise noted.

### Fluorescence Measurements.

Fluorescence was performed on a Horiba PTI QM-400 fluorometer (Irvine, CA), and the suspension (˜1 mg/mL in ethanol) were excited at 560 nm to collect the corresponding steady-state emissions.

### Confocal Microscopy and Image Analysis

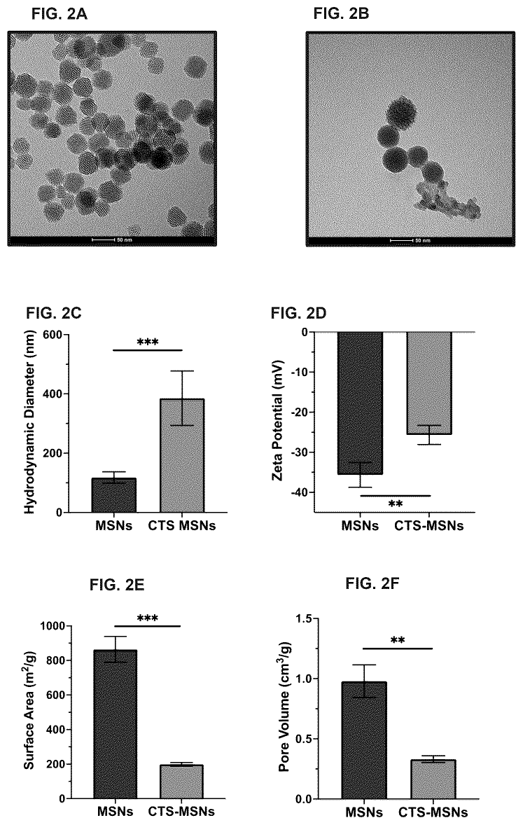

Prior to imaging, two layers of Press-to-Seal silicone spacers (Thermo Fischer) with ⅜ inch-diameter-holes were attached to No. 1.5 coverslips. Half of the seeds were placed inside the holes while allowing for the seed coat to come into contact with the coverslip (FIG. 2b). DL immersion oil was added to optimize refractive index and to stabilize the sample within the spacer.

The exterior of the half seed was imaged with a 10× objective (0.45 NA, PlanApo, WD 4 mm) using excitation wavelengths of 405, 488, 561, and 640 nm on a Nikon A1Rsi confocal microscope (Tokyo, Japan) with a 32-channel spectral detector. Spectral images were acquired with a bandwidth of 6 nm, spanning a range of 564 nm to 742 nm, to generate a lambda stack of 32 images.

Spectral images were unmixed using a linear unmixing algorithm on Nikon Elements (vers. 6.02.01) using fluorescence spectra of RITC-UMNs and APTES-modified RITC-UMNs. Once unmixed, images were processed and analyzed in FIJI (Figure S1). Upon opening the images in FIJI, the RITC channel was thresholded using percentile thresholding. Then, the wand tool was used to select a region of interest (ROI) that has the same intensity reading around the entire outside of the seed. The image was duplicated to zoom in on the ROI, and the ROI was left in place. The duplicate image was thresholded with moments thresholding. A measurement was taken, and the average intensity over the area of the ROI was recorded. The measurement also recorded the area and standard deviation, as well as the minimum and maximum threshold. Triplicate seed measurements were recorded for each condition tested. The values were averaged and plotted in GraphPad Prism for further analysis. Additionally, the seeds were inverted to place the seed interior in contact with the microscope coverslip and at the imaging plane. Similar imaging was performed; the edge of the seed was first identified based on bright field and fluorescent visualization before moving away from the edge to obtain an image of the seed interior (embryo). The seed interior was assumed to be relatively homogenous and that the selected image area was representative of that homogeneity. Unmixing was performed as described above; the unmixed images were thresholded using moments thresholding, and the average intensity was recorded for the entire image for triplicate seed measurements. To ensure consistency, only seeds that were processed in the same infiltration were compared to each other for image analysis.

Results from imaging provide feedback as relates to the infiltration into the seeds and further can be used to adjust parameters to accordingly adjust infiltration. For example, in view of the imaging and results therefrom methods described herein can be adjusted by way of adjusting one or more of a vacuum pressure, vacuum treatment time of the seeds in the suspension, a concentration of the fluorescent nanoparticles in the suspension, the composition of the suspension, the pH of the suspension, pretreatment of the seeds, or combination thereof based on the extend of infiltration based on confocal imaging results for optimization.

### Results and Discussion

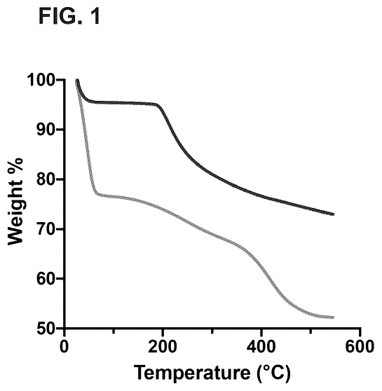

Characterization of MSNs and CTS-MSNs. TEM was used to analyze the structure of the MSNs and chitosan-coated MSNs (FIG. 2A, 2B). Both particles are spherical in shape as expected. The TEM images for MSNs show clear mesopores that are obstructed upon the addition of a chitosan coating, indicating the coating was successful. The effective hydrodynamic diameters and ζ-potentials were measured before and after chitosan coating and also confirm the presence of the coating (FIG. 2C, 2D). The hydrodynamic diameter of MSNs is approximately 117±19 nm. Upon coating MSNs with chitosan, the hydrodynamic diameter more than triples (385±92 nm), suggesting some slight aggregation of the CTS-MSNs. For MSNs, the ζ-potential is-35±3 mV while CTS-MSNs have a slightly less negative ζ-potential of −25±2 mV. The observed shift in ζ-potential upon applying a chitosan coating is attributed to the positively charged polysaccharide binding with and blocking the silanol groups on the MSNs surface. The negative ζ-potential of CTS-MSNs contradicts previous reports of chitosan-coated silica NPs.¹⁵ This is potentially due to the aggregation and instability of the CTS-MSNs, resulting in ζ-potential measurement that is representative of the colloidally stable CTS-MSNs that remain in solution. Nitrogen physisorption was performed to assess the surface area and pore volume change after applying the chitosan coating (FIG. 2E, 2F). A decrease in both surface area and pore volume supports that chitosan is coating or blocking the MSN pores, decreasing the effective internal surface area of the MSNs, as well as their overall pore volume. Thermogravimetric analysis was performed to determine the mass contribution of chitosan in the CTS-MSNs (FIG. 1).

Prior to analysis, the MSNs and CTS-MSNs were dried via rotary evaporator for 1 h. Then, 4-6 mg of dried MSNs or CTS-MSNs was weighed onto an aluminum pan and placed onto a platinum tray. The samples were analyzed using a TA Instruments Q500 Thermogravimetric Analyzer (New Castle, DE) using a temperature range of 25 to 500° C. with a ramp rate of 10° C./min and 100 mL/min nitrogen gas (40 mL/min for balance and 60 mL/min for the sample). Thermogravimetric analysis was used to assess the amount of chitosan present in the CTS-MSNs, and thermograms that are representative of the three replicates collected for MSNs and CTS-MSNs are shown in FIG. 1. The mass contribution of chitosan was calculated by subtracting the final mass remaining in the CTS-MSN sample from the final mass remaining in the MSN sample. Approximately 20% of the CTS-MSNs mass was from the chitosan coating; this information was used when determining the dose of CTS-MSNs used in greenhouse and field studies.

Based on three material replicates of CTS-MSNs, approximately 20±2% of the CTS-MSN mass was from the chitosan coating, which agrees with previously reported thermograms and ranges of chitosan coating on MSNs. (Sen Karaman, D et al. 2016). To keep the concentration of silica consistent across MSN and CTS-MSN treatments in the greenhouse and field studies, the applied concentration of CTS-MSNs was increased by 20%.

Dissolution Rates of MSNs and CTS-MSNs. Since silicic acid, a dissolution product of silica NPs in water, is the critical species for plant assimilation, the dissolution rates of both NP types were assessed ahead of greenhouse and field studies. A silicomolybdic acid spectrophotometric assay was performed to quantify the monomeric or oligomeric silicic acids released from the MSNs and CTS-MSNs. Simulated xylem sap was used as a model of natural xylem sap, which is an interior fluid of plants responsible for root-to-shoot nutrient and water transport. The dissolution was assessed over 50 days, which is approximately the length of the greenhouse and field study and also when the measured silicic acid plateaued. Over the course of 50 days, 250 mg/L of MSNs released 0.82±0.1 ppm of silicic acid which was statistically significant from CTS-MSNs that released 0.70±0.05 ppm of silicic acid. The MSNs released more silicic acid than CTS-MSNs, and the release was more rapid than the coated particles. The slower dissolution and smaller concentration of silicic acid released with chitosan coating is likely due to restricted water access to the particle's surface, slowing hydrolysis and dissolution of the CTS-MSNs. Previously, published literature has shown that concentrations of silica nanoparticles ranging from 25-1600 ppm have been beneficial for plant growth and disease suppression. While the concentration of released silicic acids from MSNs and CTS-MSNs is low, Si is not an essential nutrient for plants. Rather, it is considered a beneficial element and concentrations of silicic acid as low as 1 ppm could enhance a plant's defense mechanisms against disease; this is based on reports demonstrating that 1-3 ppm of micronutrients such as Zn, Cu, and B could enhance a plant's natural defenses.

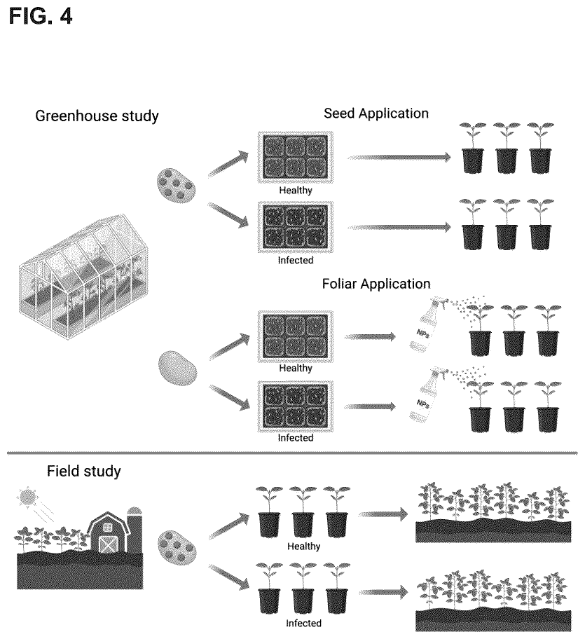

Greenhouse and Field Study. Both a greenhouse experiment and field study were carried out to study the impact of MSNs and CTS-MSNs on healthy and Fusarium-infected soybeans (See FIG. 4). In the greenhouse study, seed and foliar amendments were applied to soybeans growing in both healthy and infected soil to investigate differences in the application method of the MSNs and CTS-MSNs. Based on greenhouse results, the seed application was selected for the field study.

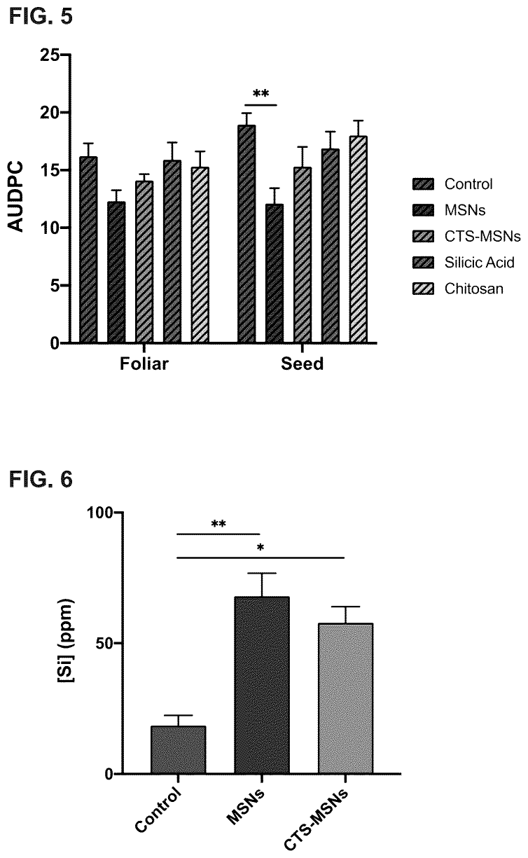

Role in Disease Suppression. In the greenhouse experiment, the impact of foliar and seed applications of MSNs and CTS-MSNs on suppressing Fusarium wilt was evaluated using the AUDPC (See FIG. 5). For infected plants, there was no change in the AUDPC for soybeans receiving the foliar application, although there is a non-significant trend that the two NP treatments performed better, with nominally lower AUDPC values. However, for seed treatments, MSN treatment resulted in a statistically significant ˜30% decrease in disease presence. This reduction is likely due to a statistically significant increase in the Si concentration (68±9 ppm) that is incorporated into the soybean seed upon MSN treatment (See FIG. 6) when compared to the untreated control (19±9 ppm), which is also greater than the Si content from the CTS-MSN treatment (58±6 ppm).

After performing vacuum infiltration of soybean seeds with 250 mg/L MSNs or CTS-MSNs, inductively couple plasma optical emission spectroscopy (ICP-OES) was used. Briefly, ˜20 seeds were dried and then ground in a mortar before being digested with nitric acid at 115° C. for 45 min. A Perkin-Elmer Optima 4300 DV ICP-OES (Shelton, CT) was used to determine the silicon content of the seeds. A statistically significant increase in silicon content was observed, with a ˜270% increase for MSNs and a ˜220% increase for CTS-MSNs (FIG. 6).

Additionally, the CTS-MSNs appeared to outperform the conventional bulk treatment, although the difference was not of statistical significance. The reduced response of CTS-MSNs and the lack of response from chitosan indicates that silica plays a larger role in bolstering the soybean defenses against Fusarium. Silicic acid also did not suppress Fusarium wilt, further highlighting the importance of the nanoscale size and/or extended dissolution for effective disease management.

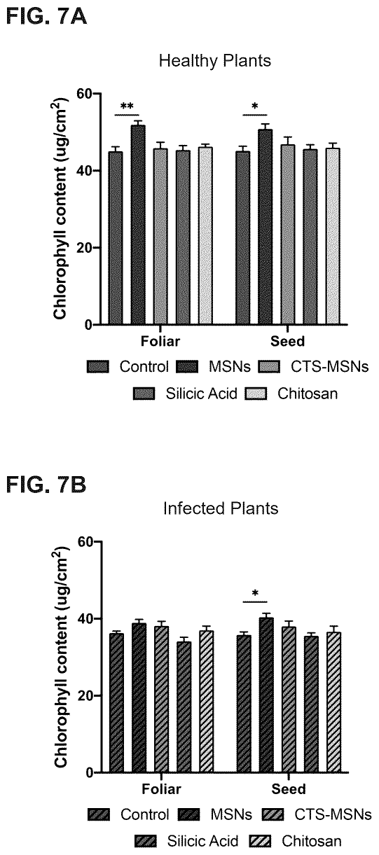

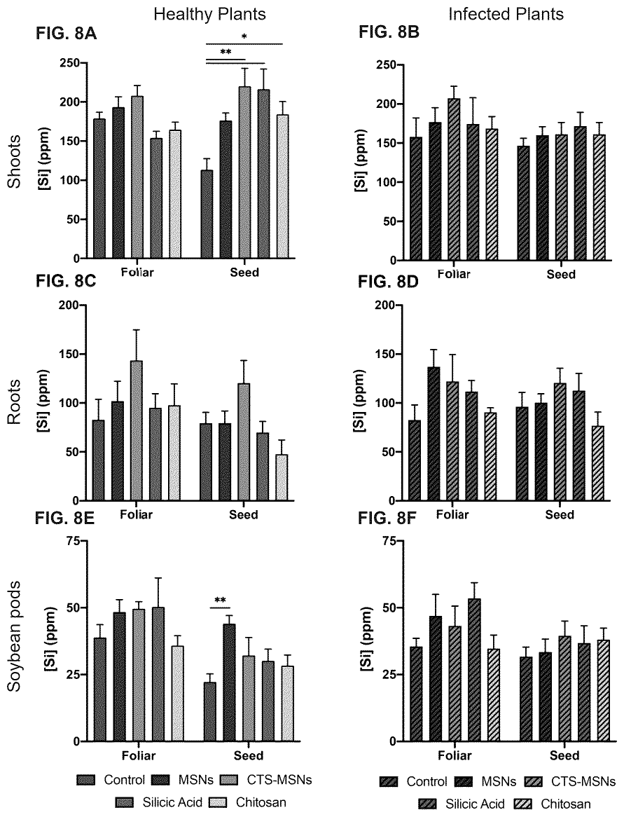

Greenhouse Chlorophyll Content. At harvest, the chlorophyll content of leaves from five plant replicates was measured as another means to assess plant health (See FIG. 7). Chlorophyll is crucial for the photosynthetic process of plants, and greater amounts of chlorophyl result in an increased potential for photosynthetic outputs, while decreased amounts serve as an indicator for soybean SDS. Additionally, plants with higher chlorophyll content often produce more nutrients, aiding the plant's resistance to environmental stresses, such as fungal infection. In this study, infection alone decreased the chlorophyll content by ˜20% with the chlorophyll content decreasing from approximately 45 μg/cm² in healthy controls to 36 μg/cm² for Fusarium-infected controls. In healthy plants, MSNs significantly increased the chlorophyll content for both foliar and seed application (˜15% and ˜12%, respectively), suggesting an increase in overall plant health and that nanoparticle treatments would be beneficial even to healthy plants. Additionally, in infected plants, chlorophyll content was significantly increased by ˜12% in plants that received the seed treatment of MSNs, almost completely alleviating the decrease induced by disease. This is supported by literature where increases in chlorophyll content have previously been correlated to overall plant health upon silica nanoparticle treatments. (Li et al 2023; Sun et al. 2016).

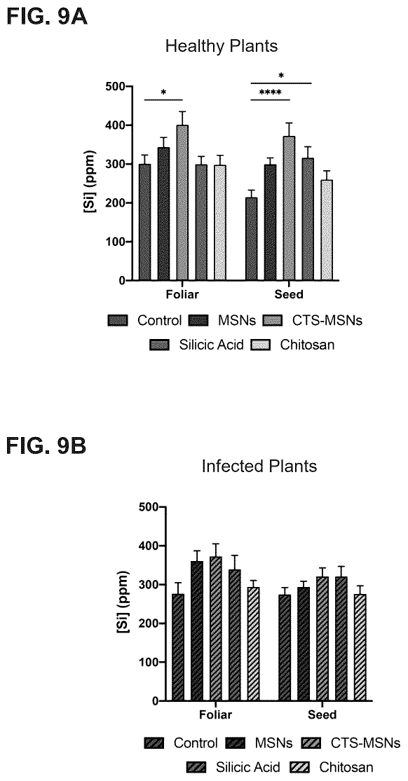

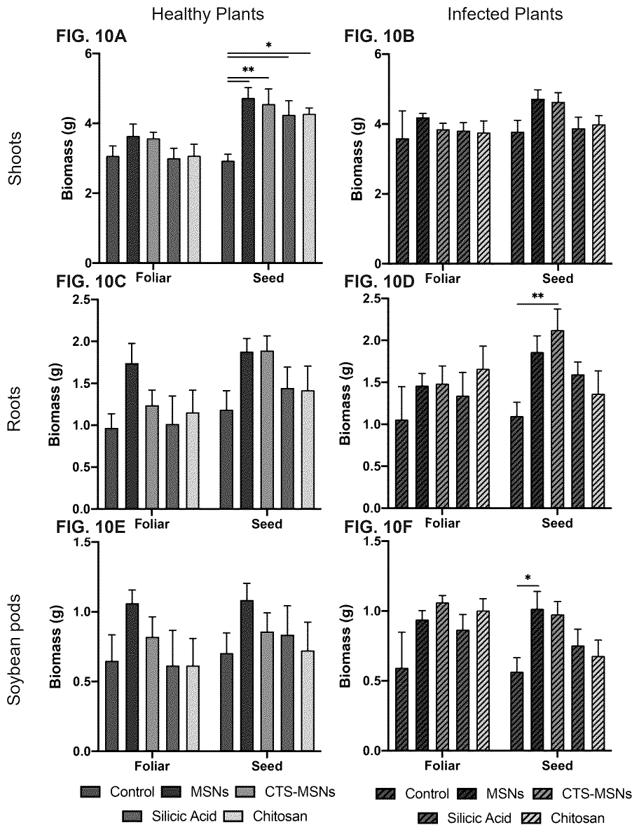

Changes in Biomass after NP Treatment. The fresh biomass was also measured for healthy and diseased plants that were treated with foliar or seed applications of MSNs and CTS-MSNs, as well as untreated controls (See FIG. 7). Disease had no impact on the biomass of shoots, roots, and pods when comparing the control groups for healthy and Fusarium-infected plants; this indicates the disease pressure was low in the greenhouse study. For healthy soybeans that were seed treated, there is a statistically different increase in the shoot masses for all treatments with a 61% increase for MSNs and a 55% increase for CTS-MSNs. However, there is a clear trend of MSNs and CTS-MSNs increasing biomasses for shoots, roots, and soybean pods for both foliar and seed applications. In infected soybeans, there are no changes or clear trends for nanoscale or bulk treatments applied foliarly. Conversely, MSN and CTS-MSN seed treatments resulted in greater biomasses for the infected soybeans with statistically significant increases for CTS-MSNs and MSNs in the roots and soybean pods, respectively. As the soybeans germinate, it is expected that the roots are the first to experience the seed treatment of MSNs and CTS-MSNs, resulting in thicker plant cell walls, greater initial protection, and subsequently higher biomasses. This is further supported by trends in the tissue element data as determined by IPC-OES (See FIG. 9A) where higher Si concentrations are observed in the roots of soybeans treated with MSNs and CTS-MSNs. Overall, MSNs and CTS-MSNs improved soybean growth in the presence and absence of Fusarium, with more differences observed with seed treatments. Based on the impact of seed treatments with MSNs and CTS-MSNs as determined by AUDPC, chlorophyll content, and biomass results, the field study was carried out using this treatment strategy.

It is challenging to reveal trends and make conclusions from the Si content changes in individual plant components (FIG. 9A) as nutritional status changes as a function of growing conditions, life cycle stage, and disease status; however, assessing the total Si content for foliar and seed treatments does provide some important insights (FIG. 9B). No changes were observed for the infected soybeans for any treatment, although all Si-based treatments did non-significantly increase the total Si content. For healthy plants, the overall Si content was significantly increased with CTS-MSN treatment by 33% for foliar treatment and 73% for seed treatment. The transport of Si to various compartments of the plant likely contributes to the trends observed in the reported biomasses, with biomass increasing for MSNs and CTS-MSNs, although high replicate variability precludes statistical significance.

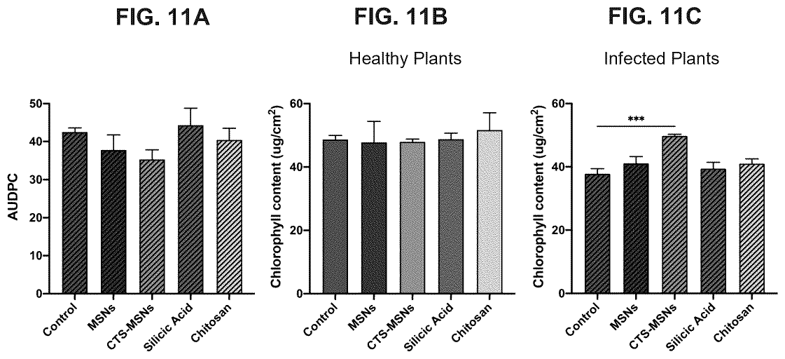

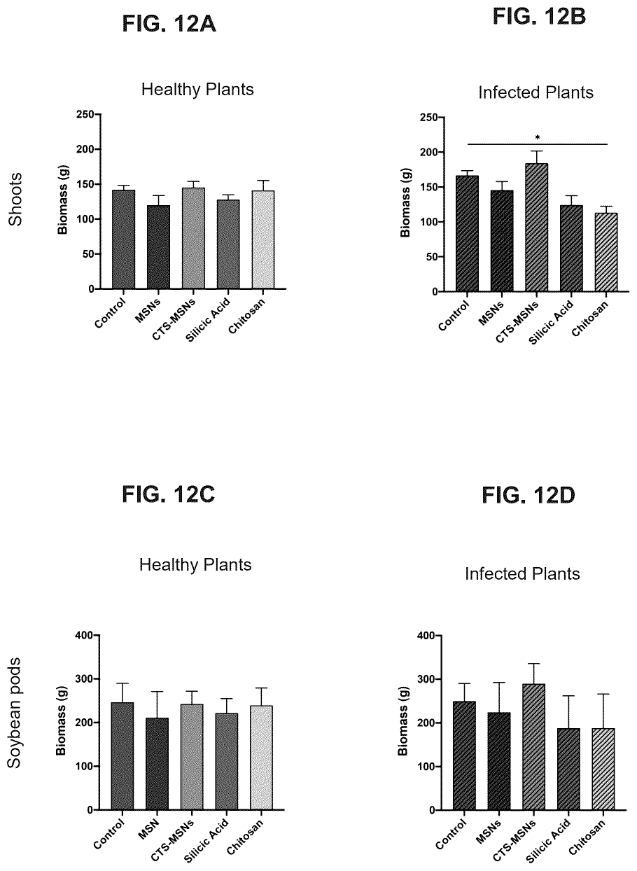

Field Study. AUDPC was also used in the field study to monitor the rate and level of disease damage (See FIG. 11A). Although there were no statistically significant changes in the AUDPC across treatments, there was a clear trend of MSNs and CTS-MSNs suppressing infection (˜12-15% AUDPC reduction) in comparison to the control, as well as the silicic acid and chitosan treatments. The lack of significant changes upon treatment may be due to the complexity of field studies, as well as the fact that overall disease pressure in this study appears to have been low. However, it should be noted that this trend with the two NP treatments reducing the AUDPC agrees with the greenhouse study.

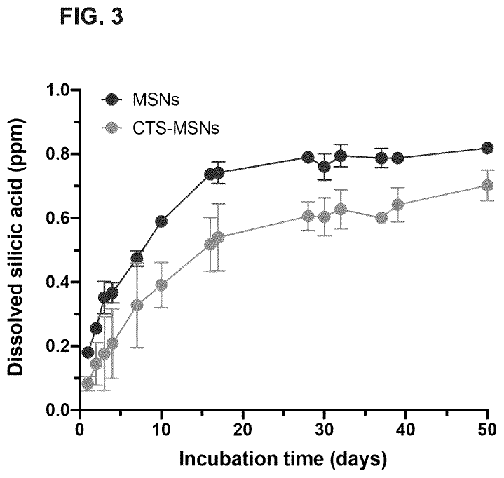

Leaf chlorophyll content was measured at harvest; overall, disease reduced chlorophyll content by ˜20% with chlorophyll content decreasing from approximately 48 μg/cm² in the healthy control to 38 μg/cm² for the infected controls. There were no changes in chlorophyll content as a function of treatment for the healthy plants (See FIG. 11B). Conversely, for infected plants, a significant increase (˜32%) in chlorophyll levels was observed for CTS-MSN-treated plants (See FIG. 11C), effectively returning the chlorophyll levels to that of the healthy control. This increase in chlorophyll aligns well with the 15% reduction in AUDPC for CTS-MSNs, clearly demonstrating that this treatment resulted in healthier plants. Notably, in the greenhouse study the MSN treatment had greater impacts on chlorophyll content, although the CTS-MSN still exerted benefit. This difference is likely the result of inherent differences between greenhouse and field studies. In the greenhouse study, MSNs aid plant growth and suppress Fusarium, showing immediate effects over the shorter term, under less than ideal growth conditions; however, in the long-term and more amenable field conditions, CTS-MSNs have more of an impact. Although the exact mechanisms for this difference remain unknown, the rate of transformation and dissolution of the particles (shown in FIG. 3 with CTS-MSNs dissolving slower than MSNs) under the different conditions could clearly be relevant. It should be noted that in both studies, the nanoscale materials still outperformed both conventional treatments.

There were few changes in biomasses across the treatments, indicating that disease pressure was very low in this field study. However, for infected plants, CTS-MSN treatment resulted in increased shoot and soybean pod masses compared to the other treatments. Notably, the chitosan and silicic acid treatments showed a reduction in the biomasses of infected plants, although the decreases were not of statistical significance. This suggests that a combination of chitosan and silica at the nanoscale is necessary for plant benefit. Larger differences are expected in a field study with higher disease pressure. However, these results agree with previous work by Kumaraswamy et al. where a chitosan-silicon nanofertilizer increased chlorophyll content and biomass in maize (Zea mays L.), enhancing crop health and yield with both a seed and foliar application. Buchman et al. also reported that CTS-MSNs significantly reduced disease severity in watermelon (Citrullus lanatus) and increased the fruit yield in healthy plants by 70% compared to the control group. Furthermore, several previous studies that have investigated other NPs on a range of plants have correlated reduced disease with increased biomass, aligning well with the trends reported herein.

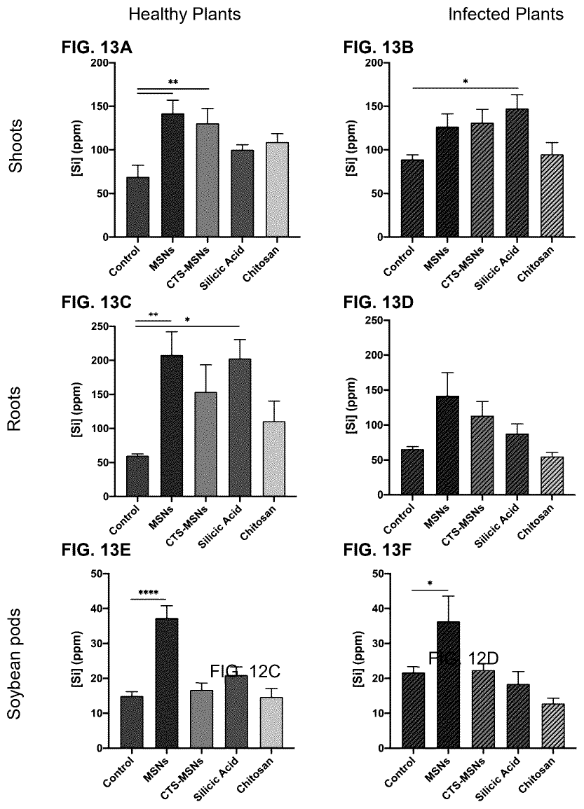

Si Content in Soybeans Post Harvest. The content of Si in shoots, roots, and soybean pods are shown in FIG. 13. In shoots (FIG. 13A, 13B), MSNs and CTS-MSNs significantly increased Si content compared to the controls under the healthy condition by 105% and 88%, respectively. For the infected plants, only silicic acid increased Si content compared with the control (by 65%); no statistically significant differences were found for the nanoscale Si-based treatments. In roots (FIG. 13C, 13D), both MSNs and silicic acid significantly increased Si content by over 200%; CTS-MSNs increased root Si content by 68%, although high replicate variability precluded statistical significance. For the infected plants, no statistically significant changes were observed as a function of treatment; however, the Si content was nominally the greatest in the MSN and CTS-MSN treatments. Notably, the pod Si content (FIG. 13E, 13F) was significantly increased by MSNs by 147% and 71% for healthy and infected plants, respectively. None of the other treatments enhanced the pod Si content. While not statistically significant, the CTS-MSNs treatment resulted in greater Si content in all plant tissues compared to controls, which likely contributed to the greater biomasses and enhanced plant health observed in this field study. Xu et al. previously reported that root exposure to Si-based nanoparticles significantly increased the Si content within shoots and edible tissues of cherry radish (Raphanus sativus L.), resulting in enhance crop health and yield. (Xu, X. et al. 2023). This effect has also been reported for rice (Orzya sativa L.) (Kheyri et al. 2019) and cucumber (Cucumis sativus L.) (Li et al. 2021). Interestingly, significant increases in Si content were observed with MSN treatments, although no corresponding increases were evident in the plant health measurements. The reason for the lack of correlations in these effects is not known, although the fact that seed or foliar treatment of seedlings resulted in increased Si content at field harvest weeks later is certainly of interest. A time-dependent molecular study (gene expression, protein, or metabolite profiling) is needed to elucidate the underlying mechanism of actions and will be subject of future work.

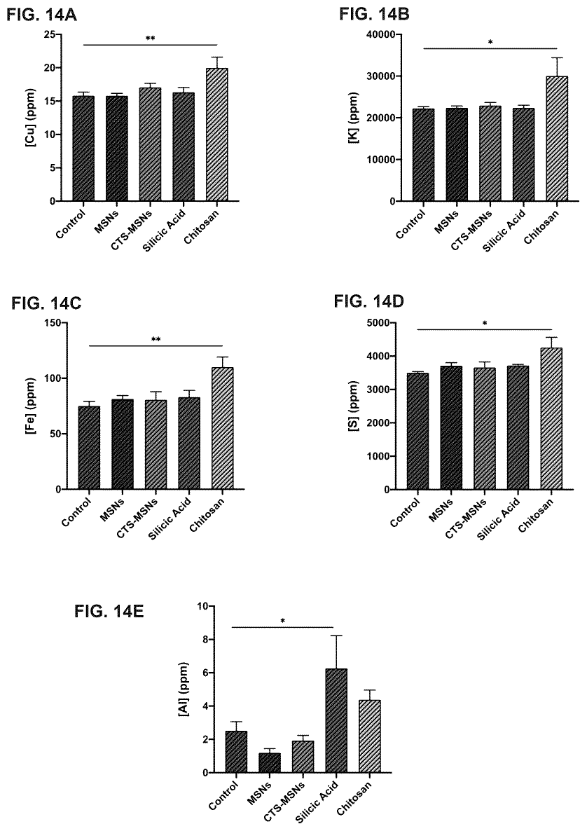

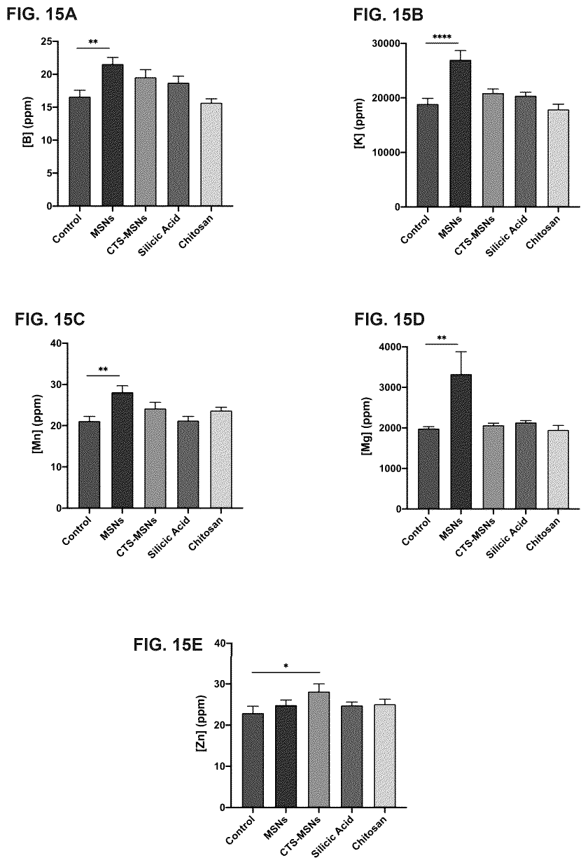

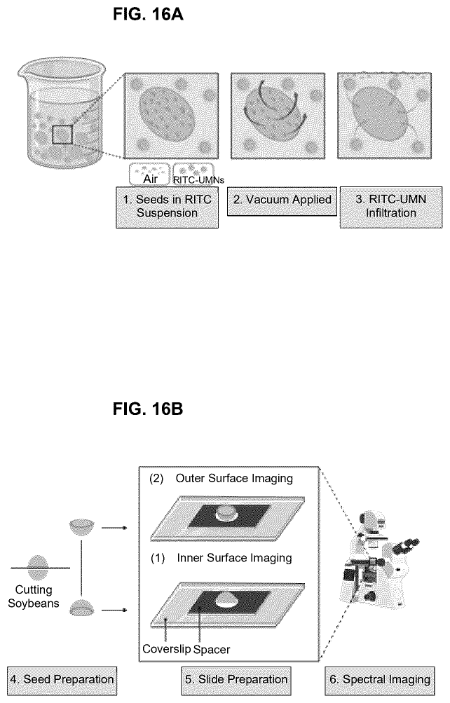

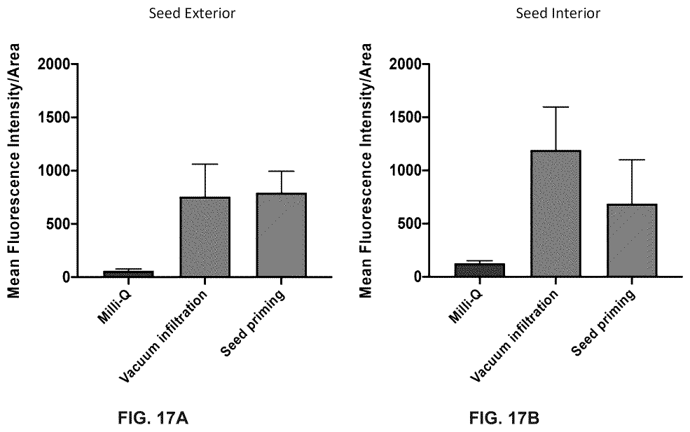

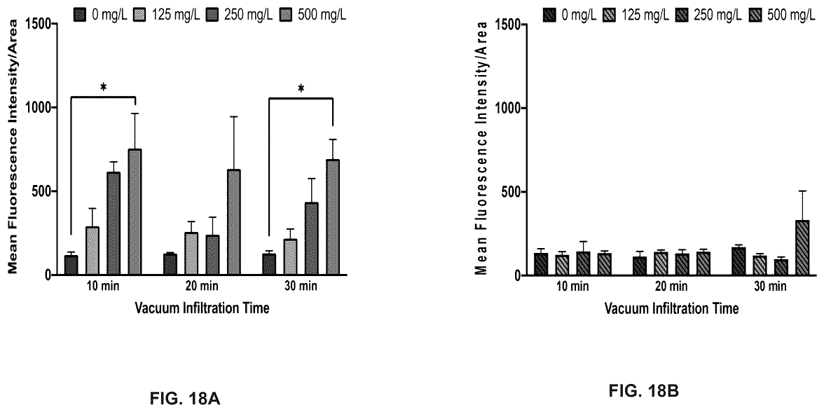

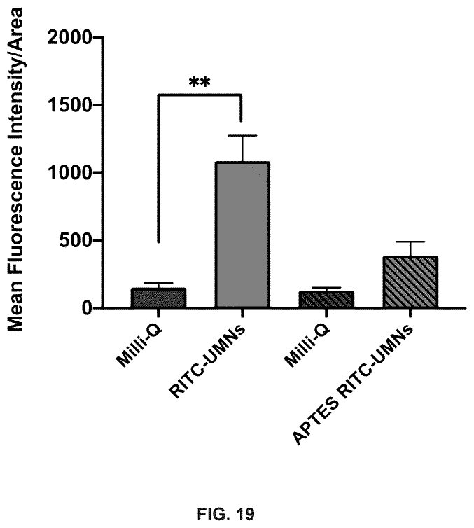

Macro-/micronutrient Accumulation. The nutritional profile of soybean pods collected from plants grown under healthy or diseased conditions in the field was determined (Sec FIG. 15). Soybeans are low silicon accumulators. In healthy pods, MSNs significantly increased the accumulation of B, K, Mn, and Mg by 30%, 43%, 33%, and 68% as compared to untreated controls, respectively (FIG. 14A-14D). Notably, the silicic acid and chitosan treatment exerted no positive impacts on pod nutritional profile. Although CTS-MSNs led to slight increases in these elements, the changes were not statistically significant. The one exception to this is Zn; CTS-MSNs exposure did significantly enhance pod Zn accumulation by 23% compared to controls, while MSNs had no such impact. However, on the whole the micronutrient profile of the pods aligns well with the Si content (FIG. 11); MSNs led to the most significant enrichment of these nutrients. Interestingly, under the stress of pathogen pressure, the micronutrient content of the pods was largely unaffected by nanoscale silica treatment (See FIG. 14). Interestingly, under the stress of pathogen pressure, the micronutrient content of the pods was largely unaffected by nanoscale silica treatment). However, chitosan treatment significantly increased the accumulation of Cu, K, Fe, and S by 27%, 35%, 47%, and 22%, respectively (FIG. 14A-14D). Silicic acid treatment increased the accumulation of A1 by 148% compared to controls (FIG. 14E).

Micronutrients such as boron (B), zinc (Zn), and manganese (Mn) are not only vital for plant growth and serve pivotal roles in cell wall construction, sugar transport, and antioxidant defense, but are also critical components of the human diet. In fact, although chronic hunger and food insecurity affects over 800 million people globally, micronutrient deficiencies or hidden hunger afflicts 2 billion persons on a daily basis. (Kah et al. 2019). Zn, in particular, holds significant importance; many agricultural soils globally suffer from Zn deficiency, which has directly led to significant human health impacts. Any sustainable strategy to promote micronutrient biofortification during routine crop cultivation is of tremendous interest. In addition, potassium (K) and magnesium (Mg) are essential micronutrients needed by plants in relatively large quantities for growth and daily functions, including chlorophyll synthesis, enzyme activation, and disease resistance. Notably, similar findings have been reported previously, although the mechanisms of action remain unknown. For instance, Dimkpa et al. discovered that chitosan-coated tripolyphosphate (TPP) nanoscale material increased sulfur(S) element accumulation in wheat grain, while uncoated TPP showed no significant changes compared to conventional fertilizer control. (Dimkpa et al. 2023). Similarly, Trujillo-Reyes et al. found that bare CeO₂ nanoparticles enhanced manganese (Mn) content in radish seedlings, whereas citric acid-coated CeO₂ did not. (Trujillo-Reyes et al. 2013). These discoveries underscore the substantial knowledge gap concerning the impact material surface chemistry properties have on the interplay between plants and nanoparticles. However, the findings provide an important foundational perspective on the potential for nano-enabled biofortification of food crops.

This study investigated the impact of MSNs and CTS-MSNs applied to soybeans (Glycine max) at the seed or seedling stage on combating damage from the fungal pathogen FV. Specifically, a greenhouse study compared the efficacy of foliar treatment to a vacuum infiltration seed treatment on healthy and Fusarium-infected soybean plants. A single seed infiltration with MSNs resulted in a reduction of disease severity by 30% which correlated well with significantly greater concentrations of in planta Si being incorporated during the infiltration process. Additionally, MSN treatment increased the chlorophyll content by 12% in both healthy and infected plants. Importantly, the conventional treatments conveyed no benefit, highlighting the importance of the privileged size or transformation products of the nanoscale materials. Based on greenhouse results, a seed treatment was also evaluated under field conditions. In the field, CTS-MSNs reduced disease severity by 15% and significantly increased chlorophyll content by 32%. Nanoscale silica treatments also significantly increased the micronutrient (Zn, Mn, Mg, K, and B) content of soybean pods by 23-68%, revealing their potential for nano-enabled biofortification of soybeans. Together, these studies show that MSNs and CTS-MSNs increase plant performance under disease pressure in the complete absence of conventional fungicides. Overall, these results show the potential of MSNs and CTS-MSNs to suppress disease associated with common and problematic fungal pathogens of soybean, while simultaneously promoting plant growth and nutritional status, providing a sustainable solution in support of nano-enabled agriculture.

What is claimed is:

1. A method for improving yield in the genus Glycine, the method comprising: applying mesoporous silica nanoparticles to a seed or plant of a member of the genus Glycine.

2. The method of claim 1 and further comprising applying chitosan to the mesoporous silica nanoparticles producing chitosan-coated mesoporous silica nanoparticles and applying the chitosan coated mesoporous silica nanoparticles to the seed or plant.

3. The method of claim 1 where the member of the genus Glycine comprises Glycine max.

4. The method of claim 1 wherein the mesoporous silica nanoparticles were applied to the plant of the member of the genus Glycine by foliar exposure to a mesoporous silica nanoparticle suspension to coat leaves of the plant with the mesoporous silica nanoparticle suspension.

5. The method of claim 1 wherein the mesoporous silica nanoparticles were applied to the seed of the member of the genus Glycine by infusing the seed with the mesoporous silica nanoparticle suspension.

6. The method of claim 5 wherein the seed is infused via a vacuum.

7. The method of claim 5 wherein the mesoporous silica nanoparticles comprise fluorescent mesoporous silica nanoparticles and further comprising subjecting the seeds with the fluorescent mesoporous silica nanoparticles infusing therein to fluorescent imaging to determine the extent of infiltration.

8. The method of claim 7 and further comprising adjusting one or more of a vacuum pressure, vacuum treatment time of the seeds in the suspension, a concentration of the fluorescent nanoparticles in the suspension, the composition of the suspension, the pH of the suspension, pretreatment of the seeds, or combination thereof based on the extend of infiltration based on confocal imaging or fluorescent imaging results for optimization.

9. The method of claim 2 wherein chlorophyll levels for a disease infected member of the genus Glycine treated with the chitosan coated mesoporous silica nanoparticles is substantially the same as for a healthy member of the genus Glycine not having been treated with the chitosan coated mesoporous silica nanoparticles.

10. The method of claim 2 wherein the application of the chitosan coated mesoporous silica nanoparticle results in a biofortification increase of approximately 23 to 86 percent of micronutrients comprising Zn, Mn, Mg, K, and/or B.

11. The method of claim 1 wherein the mesoporous silica nanoparticles are applied to the seeds or plant in an amount sufficient to reduce disease progression by approximately 12%.

12. The method of claim 2 wherein the chitosan-coated mesoporous silica nanoparticles are applied to the seed or plant in an amount sufficient to reduce disease progression by approximately 15%.

13. A method of infusing seeds from a member of the genus Glycine, with mesoporous silica nanoparticles, the method comprising:
providing a suspension of the mesoporous silica nanoparticles;
placing the seeds in the mesoporous silica nanoparticle suspension;
positioning the seeds in the mesoporous silica nanoparticle suspension in a vacuum chamber where a vacuum is pulled; and
releasing the vacuum thereby infusing the seeds with the mesoporous silica nanoparticle suspension.

14. The method of claim 13 wherein the mesoporous silica nanoparticle suspension comprises chitosan in combination with the mesoporous silica nanoparticles.

15. The method of claim 13 wherein the suspension comprises fluorescent mesoporous silica nanoparticles wherein the fluorescent mesoporous silica nanoparticles ultraporous mesostructured silica nanoparticles and are formed by a fluorescent dye integrated into the ultraporous mesostructured silica nanoparticles.

16. The method of claim 15 and further comprising:
subjecting the seeds with the fluorescent nanoparticles infiltrating therein to fluorescent imaging to determine the extent of infiltration; and
adjusting one or more of a vacuum pressure, vacuum treatment time of the seeds in the suspension, a concentration of the fluorescent nanoparticles in the suspension, the composition of the suspension, the pH of the suspension, pretreatment of the seeds, or combination thereof based on the extend of infiltration based on confocal imaging or fluorescent imaging results for optimization.

17. A method for combating Fusarium virguliforme in a member of the genus Glycine, the method comprising:
applying mesoporous silica nanoparticles to a seed of the genus Glycine.

18. The method of claim 17 and further comprising applying to the seed chitosan with the mesoporous silica nanoparticles.

19. The method of claim 17 wherein a plant resulting from the seed in a biofortification increase of approximately 23 to 86 percent of micronutrients comprising Zn, Mn, Mg, K, and/or B.

20. The method of claim 17 wherein the mesoporous silica nanoparticles are applied to the seed in an amount sufficient to reduce disease progression by approximately 12%.
